(19) United States
(12) Patent Application Publication
(10) Pub. No.: US 2026/0092460 A1
(43) Pub. Date: Apr. 2, 2026

(54) Spackle Mixing and Cleaning Device

(71) Applicant: David Gasper, Bensalem, PA (US)

(72) Inventor: David Gasper, Bensalem, PA (US)

(21) Appl. No.: 19/211,517

(22) Filed: May 19, 2025

Related U.S. Application Data
(60) Provisional application No. 63/700,127, filed on Sep. 27, 2024.

(51) Int. Cl. E04G 21/16; B01F 33/501; B01F 35/32; B01F 101/28; B08B 9/087

(52) U.S. Cl. CPC E04G 21/16; B01F 33/5011; B01F 35/3202; B08B 9/087; B01F 2101/28; B08B 2209/08

(57) ABSTRACT

A spackle mixing and cleaning device is provided. The device is designed for both mixing spackle compound and cleaning spackle trays, comprising a handle and at least one blade. The handle is ergonomically designed with a grip area that enhances control and comfort, potentially incorporating a non-slip material and textured surface for improved handling. Additional features of the handle may include a hanging hole for convenient storage, a built-in magnet for attachment to metal surfaces, and an optional belt clip for portability. The blade includes a flat member and an angled member, allowing for efficient scraping of hardened spackle from tray corners. A serrated edge facilitates thorough mixing, while an optional non-stick coating reduces material adhesion for easier cleaning.

### CROSS-REFERENCE TO RELATED APPLICATION

The present application claims priority to, and the benefit of, U.S. Provisional Application No. 63/700,127, which was filed on Sep. 27, 2024, and is incorporated herein by reference in its entirety.

### FIELD OF THE INVENTION

The present invention relates generally to the field of spackle tools. More specifically, the present invention relates to a device is designed for mixing spackle compound and cleaning spackle trays, featuring an ergonomic handle with a non-slip grip and a blade with both a flat and angled member for efficient scraping. Accordingly, the present disclosure makes specific reference thereto. Nonetheless, it is to be appreciated that aspects of the present invention are also equally applicable to other like applications, devices, and methods of manufacture.

### BACKGROUND

Applying a spackle compound requires users to mix the compound with water in a spackle tray before application. This mixing process can be time-consuming, reducing the overall efficiency of a project. If the mixture is not used within a certain timeframe, it can harden, rendering it unusable and leading to product waste. Additionally, after spackle has been applied, cleaning the tray is often difficult, particularly in the trapezoidal end of the tray, where standard spackle blades cannot easily reach. Users may spend unnecessary time scraping, chipping, or sanding dried spackle from the tray before the next use, further reducing efficiency. The inability to fully clean the tray can result in hardened residue that affects future spackle applications. Furthermore, existing tools do not effectively combine mixing and cleaning functionalities, requiring users to rely on multiple tools for these tasks. This increases the likelihood of inefficiency and inconvenience, particularly in professional and DIY construction settings.

Therefore, there exists a long-felt need in the art for a spackle tray cleaning and mixing tool that facilitates efficient mixing of dry spackle compound with water. There also exists a long-felt need in the art for a spackle tray cleaning and mixing tool that allows users to fully clean the trapezoidal corners of a spackle tray, minimizing product buildup and waste. Moreover, there exists a long-felt need in the art for a spackle tray cleaning and mixing tool that integrates ergonomic handling and convenient storage features to enhance usability and accessibility.

The subject matter disclosed and claimed herein, in one embodiment thereof, comprises a spackle mixing and cleaning device. The device is designed for both mixing spackle compound and cleaning spackle trays, comprising a handle and at least one blade. The handle is ergonomically designed with a grip area that enhances control and comfort, potentially incorporating a non-slip material and textured surface for improved handling. Additional features of the handle may include a hanging hole for convenient storage, a built-in magnet for attachment to metal surfaces, and an optional belt clip for portability. The blade includes a flat member and an angled member, allowing for efficient scraping of hardened spackle from tray corners. A serrated edge facilitates thorough mixing, while an optional non-stick coating reduces material adhesion for easier cleaning.

In this manner, the spackle mixing and cleaning device of the present invention accomplishes all the foregoing objectives and provides users with a multifunctional device designed to both mix spackle compounds efficiently and clean trays thoroughly. More specifically, the 90-degree angled member of the blade ensures that the trapezoidal corners of spackle trays can be fully cleaned, eliminating hardened residue and preventing product waste. The serrated edge of the blade further facilitates thorough mixing, reducing the time required to achieve a consistent compound. Additionally, the tool's ergonomic handle enhances user comfort during prolonged use, while built-in storage features, such as a hanging hole, magnet, and belt clip, provide multiple options for convenient organization. By integrating these features into a single device, the invention optimizes the efficiency of spackle application, cleanup, and storage, ultimately improving workflow for users.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a spackle mixing and cleaning device. The device is designed for mixing spackle compound and cleaning spackle trays and is comprised of a handle that may have an ergonomic shape for a secure grip, reducing user fatigue. The handle may also be comprised of a grip area made from non-slip materials that enhances control. In one embodiment, the handle includes a hanging hole for storage, a built-in magnet for attachment to metal surfaces, and an optional belt clip for securing to a tool belt or pocket.

A blade attaches to the handle and includes a flat member and an angled member positioned at approximately ninety degrees relative to the flat member to reach into the corners of a spackle tray. The angled member may form various angles for adaptability to different tray shapes. One edge of the blade may have a serrated edge to facilitate thorough mixing, with variations in tooth size and spacing for different mixing needs. A non-stick coating may be applied to minimize adhesion, facilitating easier cleaning. The combination of a specialized blade with an angled member ensures effective cleaning of tray corners. A serrated edge aids in mixing, while a smooth edge allows for scraping.

A method of using the device involves gripping the handle, using the serrated edge to mix spackle, applying the mixed compound with a separate tool, and then using the angled member to scrape the tray clean. The blade is then wiped clean, and the device is stored using one of the available storage options.

Accordingly, the spackle mixing and cleaning device of the present invention is particularly advantageous as it provides users with a multifunctional device designed to both mix spackle compounds efficiently and clean trays thoroughly. More specifically, the 90-degree angled member of the blade ensures that the trapezoidal corners of spackle trays can be fully cleaned, eliminating hardened residue and preventing product waste. The serrated edge of the blade further facilitates thorough mixing, reducing the time required to achieve a consistent compound. Additionally, the tool's ergonomic handle enhances user comfort during prolonged use, while built-in storage features, such as a hanging hole, magnet, and belt clip, provide multiple options for convenient organization. By integrating these features into a single device, the invention optimizes the efficiency of spackle application, cleanup, and storage, ultimately improving workflow for users. In this manner, the spackle mixing and cleaning device overcomes the limitations of existing spackle mixing and spackle tray cleaning practices and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a spackle mixing and cleaning device of the present invention in accordance with the disclosed architecture; and

FIG. 2 illustrates a flowchart of a method of using one potential embodiment of a spackle mixing and cleaning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a spackle tray cleaning and mixing tool that facilitates efficient mixing of dry spackle compound with water. There also exists a long-felt need in the art for a spackle tray cleaning and mixing tool that allows users to fully clean the trapezoidal corners of a spackle tray, minimizing product buildup and waste. Moreover, there exists a long-felt need in the art for a spackle tray cleaning and mixing tool that integrates ergonomic handling and convenient storage features to enhance usability and accessibility.

The present invention, in one exemplary embodiment, is comprised of a spackle mixing and cleaning device. The device is designed for mixing spackle compounds and cleaning spackle trays and is comprised of a handle that may feature an ergonomic shape to provide a secure grip and reduce user fatigue. The handle may also include a grip area made from non-slip materials to enhance control. In one embodiment, the handle is further comprised of a hanging hole for storage, a built-in magnet for attachment to metal surfaces, and an optional belt clip for securing the device to a tool belt or pocket.

A blade attaches to the handle and comprises a flat member along with an angled member positioned at approximately ninety degrees relative to the flat member to effectively reach into the corners of a spackle tray. The angled member may be configured at various angles to accommodate different tray shapes. One edge of the blade may include a serrated section to facilitate thorough mixing, with variations in tooth size and spacing for different mixing requirements. A non-stick coating may be applied to minimize adhesion, making cleaning easier. The combination of a specialized blade with an angled member ensures efficient cleaning of tray corners, while the serrated edge aids in mixing and the smooth edge allows for scraping.

A method of using the device involves gripping the handle, utilizing the serrated edge to mix spackle, applying the mixed compound with a separate tool, and then using the angled member to scrape the tray clean. The blade is then wiped off, and the device is stored using one of the available storage options.

As a result, the spackle mixing and cleaning device provides a multifunctional solution for efficiently mixing spackle compounds and thoroughly cleaning trays. More specifically, the 90-degree angled member of the blade ensures that the trapezoidal corners of spackle trays are fully cleaned, removing hardened residue and preventing product waste. The serrated edge of the blade enhances mixing efficiency, reducing the time required to achieve a consistent compound. Additionally, the ergonomic handle improves user comfort during extended use, while built-in storage features such as a hanging hole, magnet, and belt clip offer multiple organization options. By integrating these features into a single device, the invention optimizes the efficiency of spackle application, cleanup, and storage, ultimately improving workflow. In this manner, the spackle mixing and cleaning device addresses the limitations of existing spackle mixing and spackle tray cleaning tools known in the art.

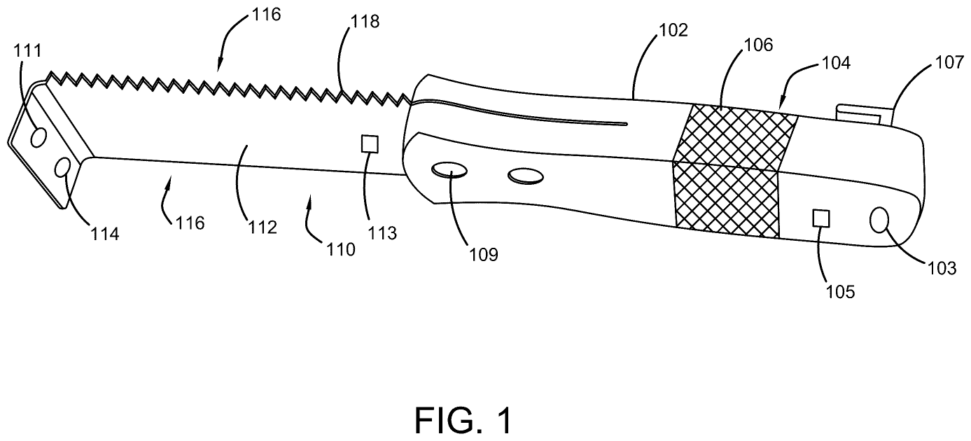

Referring initially to the drawings, FIG. 1 illustrates a perspective view of one potential embodiment of a spackle mixing and cleaning device 100 of the present invention in accordance with the disclosed architecture. The device 100 is designed for both mixing spackle compounds and cleaning spackle trays. More specifically, the device 100 is comprised of a handle 102, which may take various shapes, including, but not limited to, a contoured shape designed for ergonomic handling. The handle 102 is designed to provide a comfortable and secure grip, minimizing user fatigue during prolonged use. The handle 102 is comprised of a grip area 104, which enhances control and prevents slippage when the device 100 is in use. The grip area 104 may be made from a non-slip material such as, but not limited to, rubber, plastic, or a combination of materials that provide additional cushioning. The grip area 104 may further be comprised of a texture 106 to improve friction between the user's hand and the device 100. The texture 106 may be any type of texture, including, but not limited to, a raised texture, a recessed texture, knurling, cross-hatching, or patterned ridges, each offering varying degrees of grip enhancement depending on the user's preference and environmental conditions.

In one embodiment, the handle 102 is comprised of a hanging hole 103 positioned near the end of the handle 102 (as seen in FIG. 1), allowing for easy storage of the device 100 on pegboards, hooks, or other hanging systems. The size and shape of the hanging hole 103 may vary, accommodating different hook diameters for versatility in storage options. In one embodiment, the handle 102 is comprised of a built-in magnet 105, enabling attachment to metal trays, toolboxes, or other metal surfaces. The strength of the magnet 105 may be adjusted to ensure that the device 100 remains securely attached while still being easily removable when needed. In some variations, a belt clip 107 is included to allow users to securely attach the device 100 to a tool belt, pocket, or other carrying apparatus.

At least one blade 110 attaches to the handle 102, serving both mixing and cleaning functions. The blade 110 may be made of materials such as but not limited to stainless steel, tempered stainless steel, heat-strengthened stainless steel, blue steel, etc. In one embodiment, the blade 110 removably attaches to the handle 102 via at least one fastener 109 (as seen in FIG. 1) such as, but not limited to, a screw, a groove, a sliding lock mechanism, or a snap-fit attachment. The removability of the blade 110 allows for easy replacement or interchangeability with different blade designs suited for specific applications. The blade 110 is comprised of a flat member 112 with an angled member 114 positioned at approximately ninety degrees relative to the flat member 112. The angled member 114 is specifically designed to reach into the trapezoidal corners of a spackle tray, ensuring that hardened spackle and residual compound can be efficiently removed using the device 100. The angle of the angled member 114 may vary, forming any angle between 1 and 179 degrees relative to any axis of the flat member 112, allowing for adaptability to different tray shapes and depths.

One edge 116 of the blade 110 may be comprised of a serrated edge 118 (as seen in FIG. 1) to facilitate thorough mixing of dry spackle compound with water, improving consistency and reducing mixing time. The serrated edge 118 may vary in tooth size and spacing, with finer serrations providing smoother mixing and larger serrations allowing for more aggressive breaking of clumps. The blade 110 may also be comprised of a non-stick coating 113 that minimizes the adhesion of dried spackle, making post-use cleaning significantly easier and preventing the buildup of hardened material on the blade 110. The non-stick coating 113 may be applied using various materials, such as, but not limited to, ceramic-based coatings or other hydrophobic and oleophobic materials that resist adhesion.

As a result, the device 100 provides an efficient and practical solution for both mixing spackle and cleaning spackle trays. The combination of a specialized blade 110 with an integrated angled member 114 ensures thorough cleaning of trapezoidal tray corners, which are typically difficult to access using conventional tools. The inclusion of both a serrated edge 118 for mixing and a smooth edge 116 for scraping enhances the device's 100 versatility. By incorporating an ergonomic handle 102, the device 100 improves user comfort and reduces fatigue during prolonged use. The additional storage features, including the hanging hole 103, built-in magnet 105, and belt clip 107, further enhance convenience by providing multiple options for easy access and organization.

In one embodiment, the blade 110 is comprised of at least one opening 111 that may be positioned anywhere on the blade 110. In the preferred embodiment, the opening 111 is positioned on the angled member 114. The opening 111 improves the ability for the blade 110 to be used to mix various substances such as but not limited to spackle. In various embodiments, the opening 111 may be in the form of a slot, an angled slot, a hole, etc.

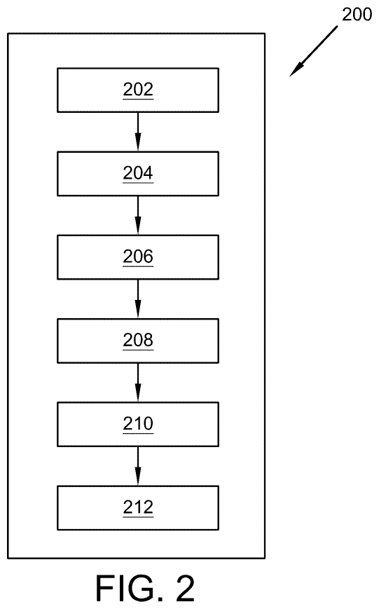

The present invention is also comprised of a method of using 200 the device 100, as seen in FIG. 2. First, a device 100 is provided, the device 100 comprising a handle 102 and at least one blade 110 attached to the handle 102 [Step 202]. Next, the user grips the handle 102 of the device 100, ensuring a firm grasp using the grip area 104 and any additional texture 106, and utilizes the blade 110 to mix the spackle compound by moving the blade 110 back and forth through the mixture, using the serrated edge 118 to break up any clumps and ensure an even consistency [Step 204]. The user may vary the mixing motion by incorporating circular, linear, or diagonal strokes depending on the texture and thickness of the spackle mixture. After the spackle compound is adequately mixed, the user applies the mixed spackle as needed using a separate application tool [Step 206]. Once the application is complete, the user grips the handle 102 and utilizes the angled member 114 of the blade 110 to scrape and remove any remaining spackle from the corners and surfaces of the spackle tray [Step 208]. The user may apply additional force or vary the scraping angle to effectively remove hardened spackle from difficult-to-reach areas. Finally, the user cleans the blade 110 by wiping off any residual spackle, with the optional non-stick coating 113 minimizing adhesion, making this process significantly easier [Step 210]. The device 100 is then stored using one of the available storage options, such as hanging the device 100 via the hanging hole 103, attaching it to a metal surface using the built-in magnet 105, or securing it to a tool belt or pocket using the belt clip 107 for future use [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “spackle mixing and cleaning device” and “device” are interchangeable and refer to the spackle mixing and cleaning device 100 of the present invention.

Notwithstanding the foregoing, the spackle mixing and cleaning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the spackle mixing and cleaning device 100 as shown in the FIGS. are for illustrative purposes only, and that many other sizes and shapes of the spackle mixing and cleaning device 100 are well within the scope of the present disclosure. Although the dimensions of the spackle mixing and cleaning device 100 are important design parameters for user convenience, the spackle mixing and cleaning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A spackle mixing and cleaning device comprising:
a handle comprising a grip area;
a blade attached to the handle, the blade comprised of:
a flat member;
an angled member positioned at 90 degrees relative to a vertical axis of the flat member.

2. The spackle mixing and cleaning device of claim 1, wherein the grip area is comprised of a non-slip material.

3. The spackle mixing and cleaning device of claim 2, wherein the non-slip material is comprised of a rubber or a plastic.

4. The spackle mixing and cleaning device of claim 1, wherein the grip area is comprised of a texture.

5. The spackle mixing and cleaning device of claim 4, wherein the texture is comprised of a raised texture, a recessed texture, a knurling, a cross-hatching, or a patterned ridge.

6. The spackle mixing and cleaning device of claim 1, wherein the handle is comprised of a magnet.

7. The spackle mixing and cleaning device of claim 1, wherein the handle is comprised of a belt clip.

8. The spackle mixing and cleaning device of claim 1, wherein the blade is comprised of a serrated edge.

9. The spackle mixing and cleaning device of claim 1, wherein the blade is comprised of a non-stick coating.

10. A spackle mixing and cleaning device comprising:
a handle comprising a grip area and a hanging hole;
a blade attached to the handle, the blade comprised of:
a flat member;
an angled member positioned between 1 and 179 degrees relative to a vertical axis of the flat member.

11. The spackle mixing and cleaning device of claim 10, wherein the grip area is comprised of a non-slip material.

12. The spackle mixing and cleaning device of claim 11, wherein the non-slip material is comprised of a rubber or a plastic.

13. The spackle mixing and cleaning device of claim 10, wherein the grip area is comprised of a texture.

14. The spackle mixing and cleaning device of claim 13, wherein the texture is comprised of a raised texture, a recessed texture, a knurling, a cross-hatching, or a patterned ridge.

15. The spackle mixing and cleaning device of claim 10, wherein the handle is comprised of a magnet.

16. The spackle mixing and cleaning device of claim 10, wherein the handle is comprised of a belt clip.

17. The spackle mixing and cleaning device of claim 10, wherein the blade is comprised of a serrated edge.

18. The spackle mixing and cleaning device of claim 10, wherein the blade is comprised of a non-stick coating.

19. A method of using a spackle mixing and cleaning device, the method comprising the following steps:
providing a spackle mixing and cleaning device comprised of a handle and a blade attached to the handle, the blade comprising a flat member and an angled member positioned at approximately ninety degrees relative to the flat member;
gripping the handle and utilizing the blade to mix a spackle compound by moving the blade through the spackle compound; and
utilizing the angled member to scrape and remove a spackle from a corner of a spackle tray.

20. The method of using a spackle mixing and cleaning device of claim 19 further comprised of a step of hanging the spackle mixing and cleaning device via a hanging hole.
